(19) United States
(12) Patent Application Publication
(10) Pub. No.: US 2011/0175299 A1
(43) Pub. Date: Jul. 21, 2011

(54) DEFORMABLE COMPOSITE SEAL FOR BEARING SURFACES WITH A GREAT LACK OF FLATNESS

(75) Inventors: Laurent Guimet, Unieux (FR); Jean-Francois Juliaa, Montelimar (FR); Michel Lefrancois, Sait Etienne (FR); Sophie Parsy, Savigneux (FR)

(73) Assignees: COMMISS. A L'ENERGIE ATOM.ET AUX ENER. ALTERN., Paris (FR); GARLOCK FRANCE SAS, Saint Etienne (FR)

(21) Appl. No.: 13/122,081

(22) PCT Filed: Oct. 9, 2009
(86) PCT No.: PCT/EP2009/063199

§ 371 Date: Mar. 31, 2011

(30) Foreign Application Priority Data
Oct. 10, 2008 (FR) 08 56879

(51) Int. Cl. F16J 15/10; F16J 15/14

(52) U.S. Cl. 277/650

(57) ABSTRACT

A seal including an outer envelope that may be made of PTFE, and an inner core including an air-permeable sack partially filled with a granular fluid. When bearing surfaces that are to be sealed are near one another, the sack is squashed, an upper volume of air escapes to the outside, and grains transmit a substantial contact pressure between lips of the envelope and the bearing surfaces. They may have moved during the squashing movement so as to even out the pressure by redistributing themselves in the sack even if there is a significant lack of flatness between the bearing surfaces.

This invention relates to a deformable composite seal for bearing surfaces with a great lack of flatness.

In aiming to transmit a sufficient contact pressure between the bearing surfaces and the seal, said pressure must be as uniform as possible. A minimum pressure is required to ensure the leak tightness of the seal. However, the leak tightness can also be compromised by the lack of flatness of the bearing surfaces if the seal is too rigid to adapt thereto, the uniformity of the pressure being lost. In addition, the contact of a rigid seal with the bearing surfaces devoid of flatness may produce excessive local pressures, particularly if the bearing surfaces are made of fragile materials. This is for example the case of enamelled flanges, for which the German standard DIN 28 007-2, for example, allows up to 8 millimetres of lack of flatness for flanges of diameter between 1000 and 2000 millimetres.

Everyday seals are thus either too rigid in producing excessive pressures or, quite the reverse, lacks of leak tightness on non flat surfaces, or too flexible, incapable of applying an adequate contact pressure.

Seals made of elastomer may give satisfaction in certain cases, but are destroyed at high temperature or in the presence of certain fluids that are to be sealed. Their use is thus not universal. Some, especially hollow or inflatable, are in any case too flexible to transmit sufficient strain on the bearing surfaces.

Another known type of leak tight seal consists in a PTFE (polytetrafluoroethylene) envelope containing a corrugated spring ensuring the contact of the envelope on the bearing surface or the bearing surfaces. An example is given in DE-U-89 14536. PTFE resists most fluids and thus resolves a deficiency of seals made of elastomer vis-à-vis the chemical compatibility with the fluids of the process. A drawback is that the corrugated spring is incapable of applying a uniform pressure on the deformed bearing surfaces.

Those skilled in the art know how to improve such seals by inserting between the spring and the envelope shims made of aramid fibres, for example, of more or less greater thickness depending on the amplitude of the local lacks of flatness. A relatively uniform contact pressure is then obtained, but the method is not reliable and it is long to implement. It is in any case doubtful that satisfactory results are obtained with significant lacks of flatness. Such conceptions are disclosed in DE-A-36 01346 or DE-A-195 39761. The document U.S. Pat. No. 5,558,347 must also be cited, in which the elastic part of the seal is composed of two corrugated springs welded together filled with gas under pressure. This more complicated design contributes to reducing the heterogeneity of the contact pressure, without eliminating it completely. The text moreover indicates that this type of leak tightness is firstly intended for enamelled flanges of diameter less than 213 millimetres.

The document U.S. Pat. No. 4,9961,891 discloses a flat seal made of cellular PTFE material, thus having a high compressibility. The structure being nevertheless porous, it cannot be allowed with certain hazardous fluids, and the seal is difficult to clean.

The document EP-0100 228 discloses a seal composed of a high viscosity mass, which can if necessary be in the form of powder or granules before a physical transformation, when the material is thermoplastic, in order to adjust better to the extreme faces of the seal; but no transmission of strains is envisaged for this seal which is not designed to serve under pressure.

The document FR-A-2 190 317, which seems to be the conception the closest to the invention, concerns a sound insulation seal for highly irregular surfaces such as the perimeter of a human ear. The contact of the seal with these surfaces is made through the intermediary of an air-impermeable sack in the form of bead closed on itself and filled with balls circulating therein by sliding against each other. The sack can lose its shape and hug the shape of the surface in contact. Such a seal is however not suited either to be applied with a uniform pressure since its capacities of transmission of strain between the bearing surfaces remain too limited.

The present invention represents an improved seal that satisfies both the necessities of being deformable enough to adapt to significant lacks of flatness but rigid to apply a sufficient contact pressure. To resume, it relates to a seal comprising a deformable envelope and a core contained in the envelope, the core being constituted of a granular fluid in a flexible sack, characterised in that the sack is air-permeable and filled in part with the granular fluid. This “granular fluid” is diphasic, it is constituted of ambient air capable of passing through the wall of the sack, or more generally gas, and capable of sliding against each other. Finally, the sack is movable in the envelope.

The partial filling of the sack by the granular fluid signifies that a volume of air remains inside the sack in addition to the interstices between the stacked grains. Since however the sack is porous, a part of this volume of air can disappear if the compression of the seal is big enough to reduce sufficiently its internal volume. The grains constituting the fluid enjoy a high mobility in the sack as long as a volume of air remains therein: they thus slide easily up to adapting to significant lacks of flatness. When the volume of air has disappeared, the transmission of pressure takes place through the contact of the balls, which withstand high contact pressures thanks to their rigidity and to the stability of their assembly, but a sliding faculty remains, which makes it possible to adjust, up to the end, excessive pressure differences from one point to another of the seal. The mobility of the sack in the envelope favours the good distribution of the balls and their flow between the bearing surfaces of the seal.

A certain elasticity of the sack may be tolerated or even preferred to enable it to extend in response to the strains and to further favour the sliding of the grains. A higher elasticity is however inadvisable since the seal would become too flexible. Which is why an essentially inextensible sack may also be proposed. If it is elastic and thus extensible, it may be reinforced with threads or other portions made of essentially inextensible material extending in a single direction of the sack, to enable the extension only in the other direction.

Rigid components, such as discs, may also be arranged near to the sack, to serve as local reinforcements to the sack, or to limit its movements and deformations to make it locally completely rigid.

The operation of the seal is improved if the envelope is made of PTFE, on which the sack slides easily. In a more particularly favourable embodiment, the envelope is made of restructured PTFE formed of a strip rolled upon itself to enclose the sack.

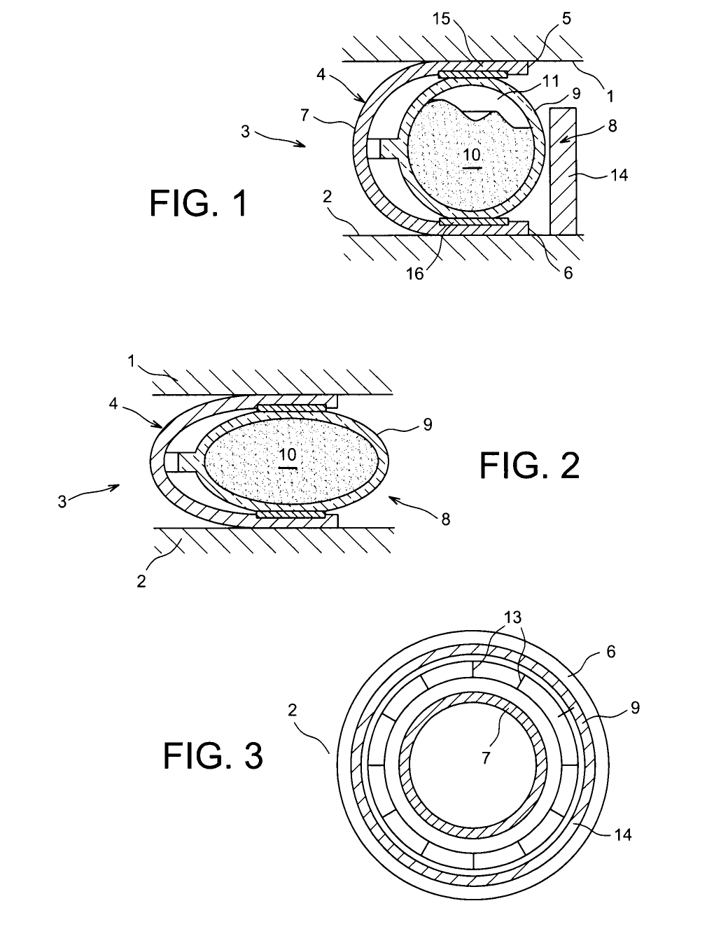

The invention will now be described with reference to FIGS. 1, 2 and 3, which represent respectively:

FIG. 1, a transversal section of the seal in the free state,

FIG. 2, a transversal section of the seal in the compressed state,

and FIG. 3, the seal in top view.

Two bearing surfaces 1 and 2 are opposite and parallel according to FIG. 1, and the seal 3 is inserted between them. It comprises an envelope 4 made of restructured PTFE of C-shaped section, composed of two lips 5 and 6 respectively resting on the bearing surfaces 1 and 2 and a curved connecting portion 7 joining the lips 5 and 6. The envelope 4 contains a core 8 composed of a sack 9 of approximately circular section in a free state filled with a granular fluid 10; a volume of air 11 remains however in the sack 9 as long as it is not compressed.

The sack 9 is deformable, air-permeable, and little or not extensible. To retain the grains 10, it is completely closed and the pores are smaller than the grains 10. It may be made of a woven or knitted material. When a compression is applied to the seal 3 by the coming together of the surfaces 1 and 2, the state of FIG. 2 is obtained. The envelope 4 is deformed, and the core 8 is compressed between the lips 5 and 6. The volume of air 11 has disappeared, evacuated via the pores of the sack 9, and the filling of grains 10 extends from one bearing surface 1 to the other 2 by the sole intermediary of the lips 5 and 6 and of the sack 9. Since these components are deformable, the state of FIG. 2 is respected for all of the sections of the assembly, despite different spacings from one place to the next between the lips 1 and 2. Slidings of the grains lessen or eliminate the local pressure variations. The material of the sack 9 is now taut, enabling the internal pressure transmitted by the grains 10 to develop. The seal of the invention may be a circular seal of conventional shape, as has been represented in FIG. 3, without other shapes being excluded.

An example of application of this seal concerns an enamelled chemical reactor constituted of a vessel surmounted by a cover. The seal 3 is arranged between them to establish the leak tightness. The temperature conditions are between the limits of −60° C. and +250° C. The internal pressure in the reactor may be between 0 bars absolute (vacuum) and 7 bars absolute. The envelope is constituted of a restructured PTFE material produced by the Garlock Company and of Gylon style 3 504 make, and the sack 9 is made of polyacrylonitrile fabric. The grains are small steel balls. Lubricant may be added to the diphasic gas-solid fluid.

Certain improvement possibilities will now be described. It has been seen that an exaggerated elasticity of the sack 9 was inadvisable. The natural elasticity may be reduced by reinforcing it with inextensible threads or fibres 13. It is possible to add them in one direction only, for example the direction of circumference of the sections, which is represented in FIG. 3. An excessive flattening of the core 8 and a reduction of the transmitted pressure are then avoided, but a greater elasticity is maintained in tangential direction of the seal 3 to facilitate the movements of the balls from one section of the sack 9 to another according to the spacing inequalities of the bearing surfaces 1 and 2.

Excessive deformations of the core 8, or excessive flattenings of the sections of the sack 9, may be avoided by appropriate obstacles, such as a cylindrical disc 14 surrounding the seal 3. Another cylindrical disc, not represented, could be arranged on the other side of the sack 9. Other discs 15 and 16, or even plates, may be inserted between the sack 9 and the lips 5 and 6. They must spread out locally the specific pressure to aid the seal 3 to adapt to the significant deformations of the bearing surfaces 1 and 2. By its elasticity properties, each of the discs 15 and 16 may help to compensate a possible creep of the corresponding lip 5 or 6; other elastic components could be inserted between the envelope 4 and the core 8 with the same effect. However, since restructured PTFE has a non-cellular structure, it also has improved creep resistance. The discs 15 and 16 may also be made of harder material to spread out more regularly the pushing force of the grains.

1-10. (canceled)

11. A seal comprising:
a deformable envelope;
a core contained in the envelope, the core being formed of a flexible sack; and
a granular fluid contained in the sack, the granular fluid being a mixture of gas and rigid balls, wherein the sack is air-permeable and only filled in part by the balls, and that it is moveable in the envelope.

12. A seal according to claim 11, wherein a pushing force of the grains is spread out on bearing surfaces that are to be sealed via intercalary discs inserted between the sack and the envelope.

13. A seal according to claim 11, wherein the sack is made of a woven or knitted material.

14. A seal according to claim 11, wherein the sack has a limited elasticity and enables lay out readjustments of the grains by sliding along a perimeter or a length of the sack.

15. A seal according to claim 11, wherein a sliding between the grains is facilitated by a lubricant.

16. A seal according to claim 14, further comprising threads of essentially inextensible material in a single direction of the sack.

17. A seal according to claim 11, further comprising rigid components arranged near to the sack to limit its movements.

18. A seal according to claim 17, wherein the rigid components are discs surrounding the sack.

19. A seal according to claim 11, wherein the envelope is made of PTFE.

20. A seal according to claim 19, wherein the envelope is a strip of restructured PTFE rolled upon itself.
